(19) United States
(12) Patent Application Publication
(10) Pub. No.: US 2018/0143608 A1
(43) Pub. Date: May 24, 2018

(54) NUMERICAL CONTROL MACHINING PATH PLANNING METHOD, AND NUMERICAL CONTROL MACHINING SYSTEM AND METHOD

(71) Applicant: SHENZHEN A&E INTELLIGENT TECHNOLOGY INSTITUTE CO., LTD., Shenzhen City, Guangdong Province (CN)

(72) Inventor: NANNAN ZHAO, Shenzhen City, Guangdong Province (CN)

(21) Appl. No.: 15/550,759

(22) PCT Filed: Jan. 28, 2016
(86) PCT No.: PCT/CN2016/072553

§ 371 Date: Dec. 18, 2017

(30) Foreign Application Priority Data
Feb. 11, 2015 (CN) 201510072437.0

(51) Int. Cl. G05B 19/19; G06F 17/10

(52) U.S. Cl. CPC G05B 19/19; G05B 2219/34149; G06F 17/10

(57) ABSTRACT

A numerical control machining path planning method and a numerical control system and method are provided are disclosed. The planning method includes: acquiring data of a first track segment AB and a second track segment BC that are adjacent before planning, wherein the first track segment AB and the second track segment BC are intersected to form a corner; calculating a distance L, a coordinate of a circle center of the transitional arc EF and coordinates of end-points E and F based on the position relationship, a radius of a transitional arc EF and a radius of at least one known track segment; and planning the corner as data for numerical control machining path by combining the data of the track segment of the transitional arc EF and the data of the two known track segments.

### TECHNICAL FIELD

Embodiments of the present disclosure generally relates to computer numerical control (CNC) machining, and in particular relate to a numerical control machining path planning method, and numerical control machining system and method.

### BACKGROUND

During a CNC machining process, the CNC system machines base on a machining program input by users. A speed will be specified as a target speed by the user in the machining program, but in general, speeds of endpoints of various machining sections are not specified. If one measure may not be taken to calculate the speeds of the endpoints, in general, a speed control strategy at the endpoints is to be machined with a speed specified by the system, or the speed is reduced to be zero at the endpoint of each section. For one corner (e.g. between a line and an arc) on a machining path, in a case where a large speed is maintained, it may fail to be transited to a next section within an allowed acceleration range for a lathe since a normal acceleration at the corner increases as the speed increases. Thus, an adverse impact will occur such as shock. If next section starts to be machined after the speed is reduced to be zero at the endpoint of the previous section, the machining quality can be ensured. However, it is not effective-cost, and when the speed is increased and then reduced frequently, the surface of a machining component will be not smooth. Even sympathetic vibration will occur, which has a server-adverse impact on the machining quality.

Thus, an arc-transition function is needed during the machining process to achieve a smooth transition between machining sections and reduce the impact on the lathe. In this way, machining efficiency and machining quality can be improved.

### SUMMARY

A numerical control machining path planning method and a numerical control machining system and method are provided for the main technical problem in present disclosure, in which arc transition can be performed between machining sections such that machining efficiency is increased, impacts on the lathe is also avoided, and machining quality is improved.

In accordance with a first aspect of the present application, a numerical control machining path planning method is provided, and the method comprising: acquiring data of a first track segment AB and a second track segment BC that are adjacent before planning, wherein the first track segment AB and the second track segment BC are intersected to form a corner; determining a position relationship between the first track segment AB and the second track segment BC according to the acquired data; calculating a distance L between circle centers based on the position relationship, a radius R₂ of a transitional arc EF and a radius R of at least one of the first track segment AB and the second track segment BC; calculating a coordinate (x_{O2}, y_{O2}) of a circle center O₂ of the transitional arc EF with the distance L and a coordinate of a circle center O of the at least one of the first track segment AB and the second track segment BC; calculating coordinates (x_{E}, y_{E}) and (x_{F}, y_{F}) of end-points E and F with the radius R₂ and the coordinate of the circle center O₂, thereby deriving data of a track segment of the transitional arc EF; and planning the corner as data for numerical control machining path by combining the data of the track segment of the transitional arc EF and the data of the first track segment AB and the second track segment BC.

In accordance with a second aspect of the present application, a numerical control machining system is provided, and the system includes a memory, a machining control module, a machining execution module, an interpolation section determination module and an arc transition module. The memory is configured to previously store a plurality of sets of numerical control machining data, wherein each set of numerical control machining data is configured to indicate a size of a component needed to be machined. The machining control module is configured to acquire numerical control machining data of the component from the memory, and generate a numerical control machining command according to the numerical control machining data. The machining execution module is configured to drive a lathe to execute a machining operation on the component in response to the numerical control machining command. The interpolation section determination module is configured to determine whether currently-executed program section data and un-executed program section data among the numerical control machining data are interpolation section data, and generate a first result to control the machining control module to obtain one program section data. The arc transition module, configured to add track data of an arc according to the first result and a second result whether a machining type described by currently-executed program section data is one of preset arc transitional types. The machining control module further configured to generate a control command according to the added track data of the arc to control the machining execution module to drive the lathe to perform corresponding machining operation on a transition section.

In accordance with a second aspect of the present application, a numerical control machining method is provided and the method includes: determining whether currently-executed program section data and un-executed program section data are interpolation section data, and generate a first result to control to obtain one program section data; add track data of an arc according to the first result and a second result whether a machining type described by currently-executed program section data is one of preset arc transitional types; and generate a control command according to the added track data of the arc to drive a lathe to perform corresponding machining operation on a transition section.

The subsequent advantages of the present disclosure may be achieved: different from the art, Whether the arc transition module is enabled is controlled by system parameters and machining commands, and arc transition data is added according to the arc transition type of the current section data and the lathe is controlled to perform machining on the transition arc when the arc transition module is enabled, increasing flexibility and improving machining efficiency.

### BRIEF DESCRIPTION OF THE DRAWINGS

FIG. 1 is a diagram illustrating a computer numerical control machining system according to an embodiment of the present disclosure.

FIG. 2 is a diagram illustrating a line track segment contacts exteriorly with a transitional arc.

FIG. 3 is a diagram illustrating a line track segment contacts interiorly with a transitional arc.

FIG. 4 is a diagram illustrating an arc track segment contacts exteriorly with a transitional arc.

FIG. 5 is a diagram illustrating an arc track segment contacts interiorly with a transitional arc.

FIG. 6 is a diagram illustrating a transitional arc is connected to two arc tracks.

FIG. 7 is a flowchart illustrating a computer numerical machining method according to an embodiment of the present disclosure.

FIG. 8 is a flowchart illustrating a computer numerical machining path planning method according to an embodiment of the present disclosure.

### DETAILED DESCRIPTION

In order to describe the technical solution, features, achieved objectives and effect, now the present disclosure will be described more clearly and completely with reference to the accompanying drawings.

As is shown in FIG. 1, which illustrates a computer numerical control (CNC) machining system according to an embodiment of the present disclosure, the CNC machining system 10 is configured for being run in a computer to control a lathe to perform corresponding numerical machining operations. The system 10 includes an arc transition module 11, an interpolation section determination module 12, a machining control module 13, a memory 14 and a machining execution module 15.

The memory 14 is configured to previously store more than one sets of numerical control machining data. Each set of numerical control machining data is used for describing a size of one machining component.

When the CNC machining system 10 performs numerical control machining on one component after being initialized, the machining control module 13 obtains numerical control machining data needed for machining components from the memory 14, and then analyzes the numerical control machining data to generate numerical control machining commands, where the numerical control machining commands includes commands for controlling the lathe to start and stop working, a command for starting and stopping of a main shaft, a command for rotation direction and rotation speed conversion, a command for direction, speed and manner of feed movement, a command for cutter selection, a command for length and radius compensation, a command for cutter replacement, and a command for opening and closing of cooling liquid, etc.

The machining execution module 15 drive the lathe to perform a corresponding machining operation in response to one numerical control machining command generated by the machining control module 13.

Further, each set of numerical control machining data includes a plurality of program sections. Each program section may be a continuous string used as one unit to be processed, configured for directing the lathe to complete or perform one action. Based on a numerical control machining process currently executed by the machining control module 13, the interpolation section determination module 12 obtains a currently-executed program section (referred as current section hereinafter) from the memory 14, and determines whether the current section is an interpolation section and whether un-executed program sections of the numerical control machining data are interpolation sections. Hence, the machining control module 13 is controlled to obtain one program section according to determination results. The arc transition module 11 is enabled or disabled in response to the determination results of the interpolation section determination module 12.

In this embodiment, the interpolation section determination module 12 sets a flag according to the determination results. The flag indicates whether there is an interpolation section. Details will be described below.

When the current section is not an interpolation section, the interpolation section determination module 12 further determines whether there exists un-transmitted interpolation section among the numerical control machining data needed to machines components. And when there doesn't exist un-transmitted interpolation section, the interpolation section determination module 12 transmits the current section to the machining control module 13. The machining control module 13 sends a corresponding control command to the numerical control execution module 15 based on the current section, such that the numerical control execution module 15 drive the lathe to perform a corresponding machining operation. Meanwhile, the flag is not set by the interpolation section determination module 12. At this time, the arc transition module 11 is disabled.

When the current section is not an interpolation section, and there exists un-transmitted interpolation section of the numerical control machining data, the interpolation section determination module 12 transmits the current section to the machining control module 13, and meanwhile sets the flag as 0. At this time, the arc transition module 11 is enabled.

When the current section is an interpolation section, and there does not exist un-transmitted interpolation section of the numerical control machining data, the interpolation section determination module 12 transmits the current section to the machining control module 13, and meanwhile set the flag as 1. At this time, the arc transition module 11 is enabled.

When the current section is an interpolation section, and there exists un-transmitted interpolation section of the numerical control machining data, the interpolation section determination module 12 directly control the arc transition module 11 to be enabled. The arc transition module 11 determines whether a machining type described by the current section is one of preset arc transition types. In this embodiment, the preset arc transition types includes that a type in which a line track segment is exteriorly connected to the transitional arc, a type in which a line track segment inscribes the transitional arc, a type in which an arc track segment is exteriorly connected to the transitional arc, a type in which an arc track segment is interiorly connected to the transitional arc, and a first arc track segment and a second arc track segment is interiorly and exteriorly connected to the transitional arc, respectively.

When the machining type described by the current section isn't one of the preset arc transition types, the interpolation section determination module 12 stores the current section into a previous section, meaning that it omits the current section. When the machining type described by the current section is one of the preset arc transition types, the arc transition module 11 adds an arc track segment corresponding to the one of the preset arc transition types.

The arc track segment is stored into the memory 14 in advance. The arc transition module 11 obtains the arc track segment according to the determined arc transition types.

The machining control module 13 generates a control command based on the added arc track segment to call the machining execution module 15 to drive the lathe to perform a corresponding machining operation on the arc transitional section. As mentioned above, the CNC machining system 10 adds the arc track segment according to a machining type described by the current section, and then complete arc transition between any machining sections.

The principle for determining what the arc transition type it is and the algorithm for determining the track segment of an arc are described in accompanying with the preset arc transition types.

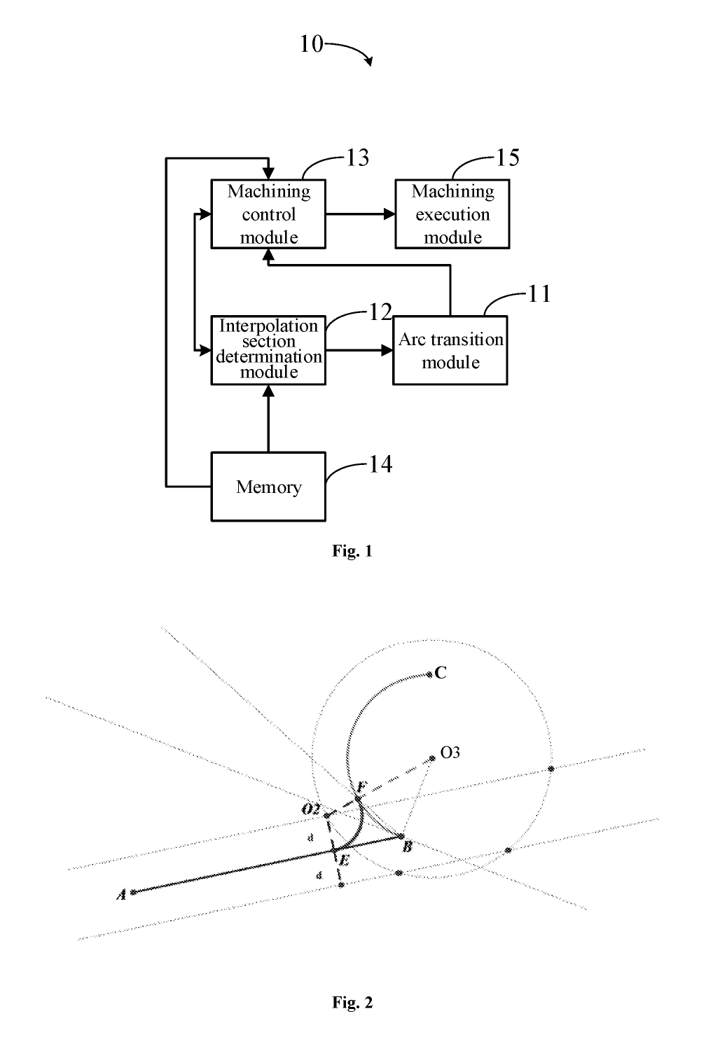

Referring to FIG. 2, a first track segment AB is a straight line and a second track segment BC is an arc, where an arc EF is a transitional arc, both the straight line AB and the arc BC are machining tracks of one component, O₃ is the circle center of the arc BC, O₂ is the circle center of the transitional arc EF, and point B is the intersection point of the straight line AB and the arc BC. The point E of the transitional arc EF is a tangent point between the transitional arc EF and the straight line AB, point F is a tangent point between the transitional arc EF and the arc BC, and the direction of the transitional arc EF is opposite to that of the arc BC.

When ∠ABO₃>90°, the position relationship between the first track segment AB and the second track segment BC is that the first track segment AB is exteriorly connected to the second track segment BC.

$$R 2 = \frac{\vert ( {y}_{B} - {y}_{A} ) {x}_{{O}_{2}} + ( {x}_{A} - {x}_{B} ) {y}_{{O}_{2}} + ( {x}_{B} {y}_{A} - {x}_{A} {y}_{B} ) \vert}{\sqrt{{( {y}_{B} - {y}_{A} )}^{2} + {( {x}_{B} - {x}_{A} )}^{2}}} \qquad ( 1 )$$

Wherein (x_{A}, y_{A}) denotes a coordinate of point A and (x_{B}, y_{B}) denotes a coordinate of point B, which are known.

A distance between the circle center O₂ and the circle center O₃ is calculated with a following formula (2):

L₃₂=\sqrt{(y_{O3}−y_{O2})²+(x_{O3}−x_{O2})²}=R₃+R₂ (4)

(x_{O3}, y_{O3}) denotes coordinate of the circle center O₃, R₃ is a radius of the circle O₃ and R₂ is a radius of the circle O₂, which are all known. (x_{O2}, y_{O2}) denotes the coordinate of the circle center O₂, which is un-known.

The coordinate (x_{O2}, y_{O2}) of the circle center O₂ is calculated by both formula (1) and formula (4).

As mentioned above, the calculated coordinate (x_{O2}, y_{O2}) of the circle center O₂ has four sets of solutions. Furthermore, a screening condition is set to obtain a final value of the coordinate (x_{O2}, y_{O2}) from the four sets of solutions. The screening condition is that the direction from point B to point C of the arc BC is set as a positive direction after the circle centers O₃ and O₂ are connected, such that a solution which makes a value of ∠BO₃O₂ minimum is determined as what is needed, and thus the coordinate (x_{O2}, y_{O2}) of the circle center O₂ is determined finally.

Then, the coordinates (x_{E}, y_{E}) and (x_{F}, y_{F}) of the end-points E and F are calculated respectively based on the coordinate (x_{O2}, y_{O2}) of the circle center O₂ and following formulas (3) and (4).

\sqrt{(y_{O3}−y_{B})²+(x_{O3}−x_{B})²}=\sqrt{(y_{O3}−y_{F})²+(x_{O3}−x_{F})²}=R₃ (2)

\sqrt{(y_{O2}−y_{E})²+(x_{O2}−x_{E})²}=\sqrt{(y_{O2}−y_{F})²+(x_{O2}−x_{F})²}=R₂ (3)

Therefore, an arc with the circle center O₂ and end points E and F is the needed transitional arc.

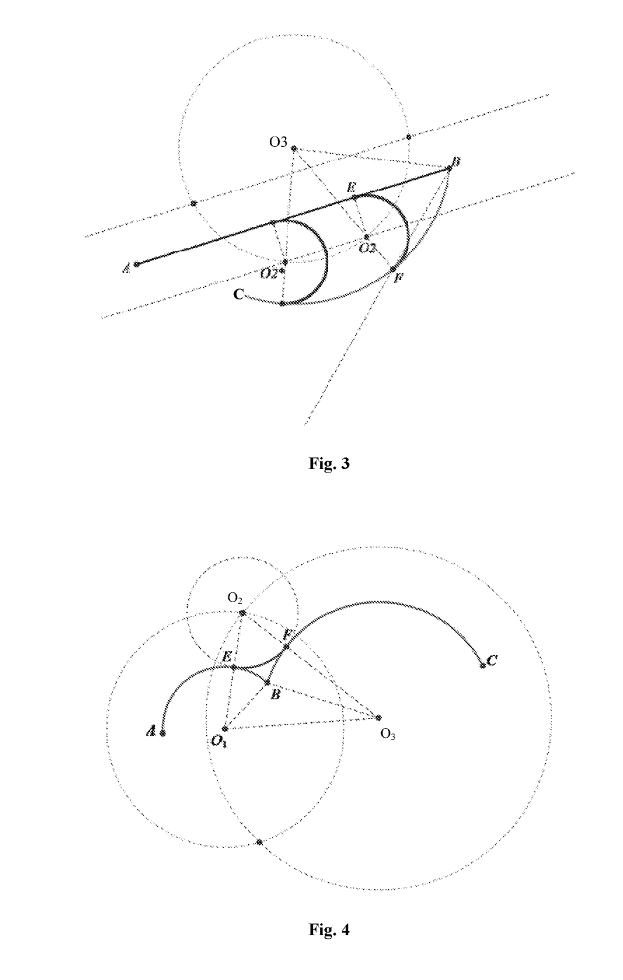

Referring to FIG. 3, a first track segment AB is a straight line and a second track segment BC is an arc, where an arc EF is a transitional arc, both the straight line AB and the arc BC are machining tracks of one component, O₃ is the circle center of the arc BC, O₂ is the circle center of the transitional arc EF, and point B is the intersection point of the straight line AB and the arc BC. The point E of the transitional arc EF is a tangent point between the transitional arc EF and the straight line AB, point F is a tangent point between the transitional arc EF and the arc BC, and the direction of the transitional arc EF is same with that of the arc BC.

When ∠BO₃<90°, the position relationship between the first track segment AB and the second track segment BC is that the first track segment AB circumscribes the second track segment BC.

A distance between the circle center O₂ and the circle center O₃ is calculated with a following formula (5):

L₃₂=\sqrt{(y_{O3}−y_{O2})²+(x_{O3}−x_{O2})²}=R₃−R₂ (5)

(x_{O3}, y_{O3}) denotes coordinate of the circle center O₃, R₃ is a radius of the circle O₃ and R₂ is a radius of the circle O₂, which are all known. (x_{O2}, y_{O2}) denotes the coordinate of the circle center O₂, which is un-known.

The coordinate (x_{O2}, y_{O2}) of the circle center O₂ is then calculated by the formulas (1) and (5) together.

As afore-mentioned, the calculated coordinate (x_{O2}, y_{O2}) of the circle center O₂ has four sets of solutions. Furthermore, a screening condition is set to obtain a final value of the coordinate (x_{O2}, y_{O2}) from the four sets of solutions. The screening condition is that the direction from point B to point C of the arc BC is set as a positive direction after the circle centers O₃ and O₂ are connected, such that a solution which makes a value of ∠BO₃O₂ minimum is determined as what is needed, and thus the coordinate (x_{O2}, y_{O2}) of the circle center O₂ is determined finally.

As afore-mentioned, the calculated coordinate (x_{O2}, y_{O2}) of the circle center O₂ has four sets of solutions. Furthermore, a screening condition is set to obtain a final value of the coordinate (x_{O2}, y_{O2}) from the four sets of solutions. The screening condition is that the direction from point B to point C of the arc BC is set as a positive direction after the circle centers O₃ and O₂ are connected, such that a solution which makes a value of ∠BO₃O₂ minimum is determined as what is needed, and thus the coordinate (x_{O2}, y_{O2}) of the circle center O₂ is determined finally.

Then, the coordinates (x_{E}, y_{E}) and (x_{F}, y_{F}) of the end-points E and F are calculated respectively based on the coordinate (x_{O2}, y_{O2}) of the circle center O₂ and following formulas (2) and (3).

\sqrt{(y_{O3}−y_{B})²+(x_{O3}−x_{B})²}=\sqrt{(y_{O3}−y_{F})²+(x_{O3}−x_{F})²}=R₃ (2)

\sqrt{(y_{O2}−y_{E})²+(x_{O2}−x_{E})²}=\sqrt{(y_{O2}−y_{F})²+(x_{O2}−x_{F})²}=R₂ (3)

Therefore, an arc with the circle center O₂ and end points E and F is the needed transitional arc.

Further, when following cases occurs, the needed transitional arc cannot be obtained using the afore-mentioned formulas.

Case 1: a length of line BE is larger than a length of line AB. In this case, the line AB is too short to draw a transitional radius between the line and the arc to form a transitional arc.

Case 2: central angle ∠BO₁F is greater than central angel ∠BO₁C corresponding to a given arc CF when obtaining the point F of the transitional arc EF. In this case, the given arc CF is too short to draw a transitional radius between the line and the arc to form a transitional arc.

Case 3: if height formed when the given arc CF is cut by the given straight line AB is twice smaller than a central radius of the transitional arc. In this case, no enough face is determined to form a transitional arc.

Referring to FIG. 4, both a first track segment AB and a second track segment BC are arcs, where an arc EF is a transitional arc, both the arc AB and the arc BC are machining tracks of one component, O₁ is the circle center of the arc BC, O₃ is the circle center of the arc BC, O₂ is the circle center of the transitional arc EF, and point B is the intersection point of the straight line AB and the arc BC. The point E of the transitional arc EF is a tangent point between the transitional arc EF and the arc AB, point F is a tangent point between the transitional arc EF and the arc BC.

As a selected direction vector gets through the first track segment AB and the second track segment BC, and the rotary direction of ∠O₁BO₃ is opposite to that of ∠ABC, it is determined that the rotary direction of the first track segment AB is same with that of the second track segment BC and the position relationship therebetween is that the first track segment AB is exteriorly connected to the second track segment BC.

A distance between the circle center O₁ and the circle center O₂ is calculated with a following formula (6):

L₁₂=R₁+R₂=\sqrt{(x_{O1}−x_{O2})²+(y_{O1}−y_{O2})²} (6).

A distance between the circle center O₂ and the circle center O₃ is calculated with a following formula (7):

L₃₂=R₂+R₃=\sqrt{(x_{O2}−x_{O3})²+(y_{O2}−y_{O3})²} (7),

(x_{O1}, y_{O1}) denotes coordinate of the circle center O₁, R₁ is a radius of the circle O₁, R₂ is a radius of the circle O₂, (x_{O3}, y_{O3}) denotes coordinate of the circle center O₃, and R₃ is a radius of the circle O₃, which are all known. (x_{O2}, y_{O2}) denotes the coordinate of the circle center O₂, which is un-known.

The coordinate of the circle center O₂ is calculated with the formulas (6) and (7).

As afore-mentioned, the calculated coordinate (x_{O2}, y_{O2}) of the circle center O₂ has two sets of solutions. A screening condition is set to finally determine the coordinate (x_{O2}, y_{O2}) of the circle center O₂, which is that one solution which is nearer to the intersection point B is used as the coordinate (x_{O2}, y_{O2}) of the circle center O₂.

Then, the coordinates (x_{E}, y_{E}) and (x_{F}, y_{F}) of the end-points E and F are calculated respectively based on the coordinate (x_{O2}, y_{O2}) of the circle center O₂ and following formulas (8)-(10).

\sqrt{(y_{O1}−y_{E})²+(x_{O1}−x_{E})²}=R₁ (8)

\sqrt{(y_{O3}−y_{F})²+(x_{O3}−x_{F})²}=R₃ (9)

\sqrt{(y_{O2}−y_{F})²+(x_{O2}−x_{F})²}=\sqrt{(y_{O2}−y_{E})²+(x_{O2}−x_{E})²}=R₂ (10).

Therefore, an arc with the circle center O₂ and end points E and F is the needed transitional arc.

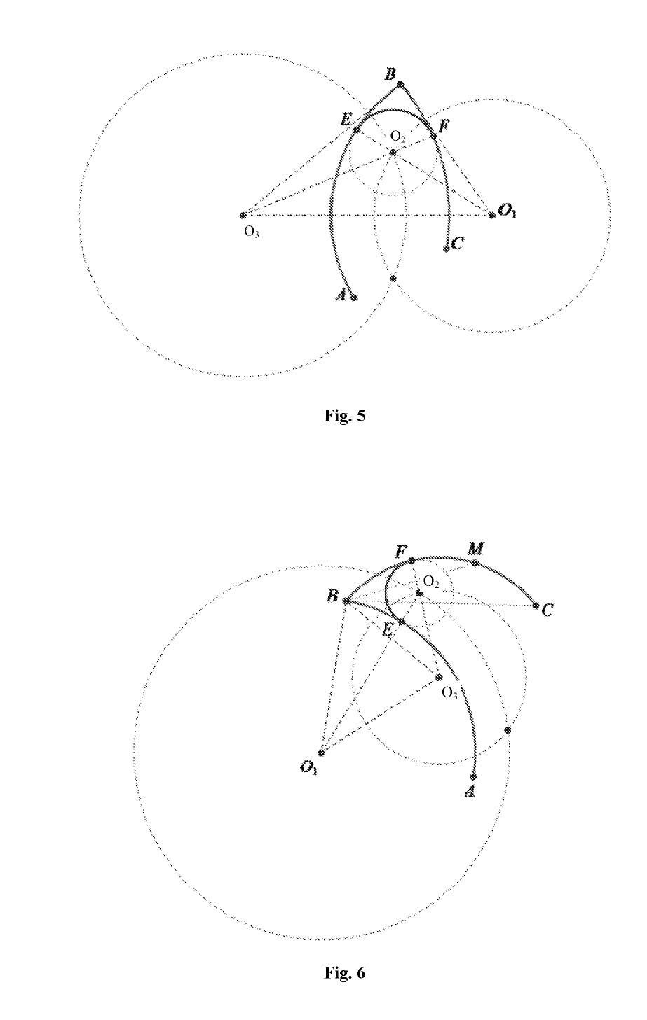

Referring to FIG. 5, both a first track segment AB and a second track segment BC are arcs, where an arc EF is a transitional arc, both the arc AB and the arc BC are machining tracks of one component, O₁ is the circle center of the arc BC, O₃ is the circle center of the arc BC, O₂ is the circle center of the transitional arc EF, and point B is the intersection point of the straight line AB and the arc BC. The point E of the transitional arc EF is a tangent point between the transitional arc EF and the arc AB, point F is a tangent point between the transitional arc EF and the arc BC.

As a selected direction vector gets through the first track segment AB and the second track segment BC, and the rotary direction of ∠O₁BO₃ is same with that of ∠ABC, it is determined that the rotary direction of the first track segment AB is same with that of the second track segment BC and the position relationship therebetween is that the first track segment AB is interiorly connected to the second track segment BC.

A distance between the circle center O₁ and the circle center O₂ is calculated with a following formula (11):

L₁₂=R₁−R₂=\sqrt{(x_{O1}−x_{O2})²+(y_{O1}−y_{O2})²} (11)

A distance between the circle center O₂ and the circle center O₃ is calculated with a following formula (12):

L₃₂=R₃−R₂=\sqrt{(x_{O3}−x_{O2})²+(y_{O3}−y_{O2})²} (12)

(x_{O1}, y_{O1}) denotes coordinate of the circle center O₁, R₁ is a radius of the circle O₁, (x_{O3}, y_{O3}) denotes coordinate of the circle center O₃, and R₃ is a radius of the circle O₃, which are all known. (x_{O2}, y_{O2}) denotes the coordinate of the circle center O₂, which is un-known.

The coordinate of the circle center O₂ is calculated with the formulas (11) and (12).

As afore-mentioned, the calculated coordinate (x_{O2}, y_{O2}) of the circle center O₂ has two sets of solutions. A screening condition is set to finally determine the coordinate (x_{O2}, y_{O2}) of the circle center O₂, which is that one solution which is nearer to the intersection point B is used as the coordinate (x_{O2}, y_{O2}) of the circle center O₂.

Similarly, the coordinates (x_{E}, y_{E}) and (x_{F}, y_{F}) of the end-points E and F are calculated respectively based on the coordinate (x_{O2}, y_{O2}) of the circle center O₂ and following formulas (8)-(10). Therefore, an arc with the circle center O₂ and end points E and F is the needed transitional arc.

Referring to FIG. 6, both a first track segment AB and a second track segment BC are arcs.

Whether a known arc is a top-arc or bottom-arc is determined according to a convex direction of a known arc (which is the first track segment AB or the second track segment BC). The top-arc is an arc which inscribes the transitional arc. The bottom-arc is an arc which is exteriorly connected to the transitional arc.

In specific, the convex direction is defined as follows. Taking arc BC as an example, any one point Mon the arc BC is selected except for end points, and point B is connected to points M and C respectively. If the position which BM is located may be obtained by rotating BC with θ(0˜90°) clockwise, the arc BC is called as a clockwise convex for the point B. In other word, the convex direction of the arc BC is clockwise for the point B. Obviously, in this case, the direction of the arc BC is same with that of the arc AB.

For the arc AB (of which circle center is O₁ and radius is R₁) and the arc BC (of which circle center is O₃ and radius is R₃) which are adjacent, the direction (i.e. rotary direction) of ∠O₁BO₃ formed by connecting the point B to O₁ and O₃ is same with the directions of the two arcs which are intersected at the point B, the arc AB is the bottom-arc of a transitional circle, and the arc BC is the top-arc. The relationships between distances L₁₂ and L₃₂ and a radius R₂ of the transitional circle, the radiuses R₁ and R₃ are listed as follows.

L₁₂=R₁+R₂=\sqrt{(x_{O1}−x_{O2})²+(y_{O1}−y_{O2})²} (13)

L₃₂=R₃−R₂=\sqrt{(x_{O3}−x_{O2})²+(y_{O3}−y_{O2})²} (14).

On the contrary, the relationships are listed as follows.

L₁₂=R₁−R₂=\sqrt{(x_{O1}−x_{O2})²+(y_{O1}−y_{O2})²} (15)

L₃₂=R₃+R₂=\sqrt{(x_{O3}−x_{O2})²+(y_{O3}−y_{O2})²} (16).

Therefore, when the transitional arc EF inscribes the top-arc EC and is exteriorly connected to the bottom-arc AB, the coordinate of the circle center O₂ is calculated with the formulas (13) and (14) or (15) and (16).

As afore-mentioned, the calculated coordinate (x_{O2}, y_{O2}) of the circle center O₂ has two sets of solutions. A screening condition is set to finally determine the coordinate (x_{O2}, y_{O2}) of the circle center O₂, which is that one solution which is nearer to the intersection point B is used as the coordinate (x_{O2}, y_{O2}) of the circle center O₂.

Similarly, the coordinates (x_{E}, y_{E}) and (x_{F}, y_{F}) of the end-points E and F are calculated respectively based on the coordinate (x_{O2}, y_{O2}) of the circle center O₂ and following formulas (8)-(10). Therefore, an arc with the circle center O₂ and end points E and F is the needed transitional arc.

In addition, when a case occurs, the needed transitional arc cannot be obtained using the afore-mentioned formulas. In the case where the two arcs are interiorly connected or mixed to be connected, if the radius of the transitional circle is set too largely, a complex solution will occur, meaning there is no solutions and the radius of the transitional circle needs to be adjusted.

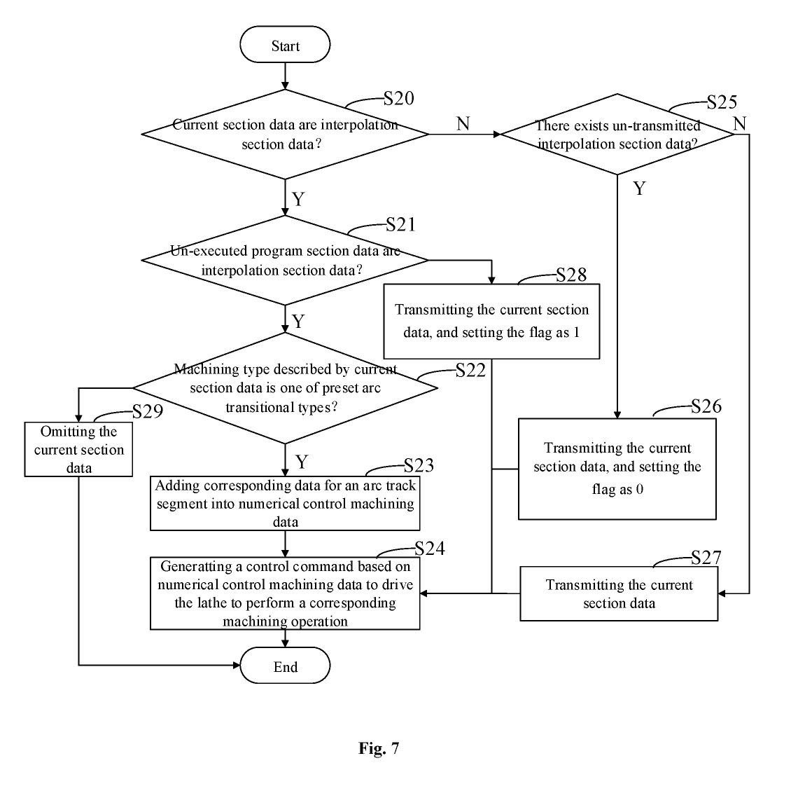

Referring to FIG. 7, it is a flowchart illustrating a computer numerical machining method according to an embodiment of the present disclosure.

In block S20: the interpolation section determination module 12 determines whether currently-executed program section data are interpolation section data when the CNC machining system 10 performs numerical control machining on a component after initiating. Block S21 will be executed when it is. Otherwise, block S25 will be executed.

In the block S21: the interpolation section determination module 12 determines whether un-executed program section data are interpolation section data. Block S22 will be executed when it is. Otherwise, block S28 will be executed.

In the block S22: the arc transition module 11 is enabled in response to a determination result of the interpolation section determination module 12, and determines whether a machining type described by currently-executed program section data is one of preset arc transitional types. Block S23 will be executed when it is. Otherwise, block S29 will be executed.

In this embodiment, the preset arc transition types includes that a type in which a line track segment is exteriorly connected to the transitional arc, a type in which a line track segment inscribes the transitional arc, a type in which an arc track segment is exteriorly connected to the transitional arc, a type in which an arc track segment is interiorly connected to the transitional arc, and a first arc track segment and a second arc track segment is interiorly and exteriorly connected to the transitional arc, respectively.

In the block S23: the arc transition module 11 adds data for an arc track segment corresponding to the one of the preset arc transition types into numerical control machining data.

The data for the arc track segment is stored into the memory 14 in advance. The arc transition module 11 obtains the arc track segment according to the determined arc transition types.

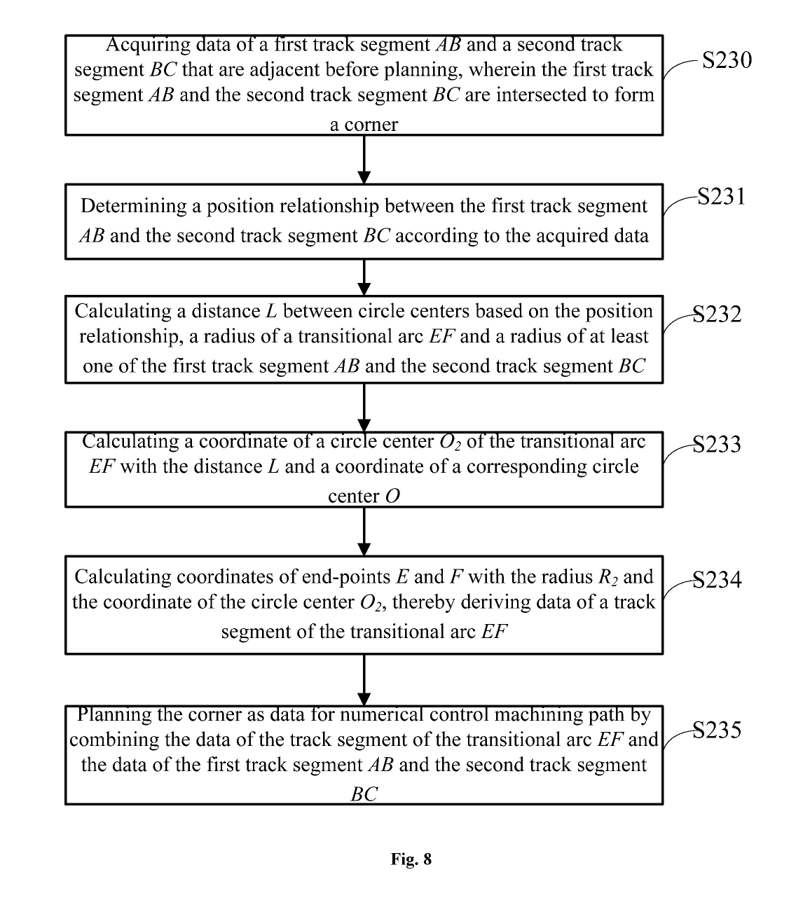

Referring to FIG. 8 together, which is a flowchart illustrating a computer numerical machining path planning method according to an embodiment of the present disclosure. The method is used for determining data for the arc track segment, which comprises the following blocks.

In sub-block S230: data of a first track segment AB and a second track segment BC that are adjacent before planning are acquired, wherein the first track segment AB and the second track segment BC are intersected to form a corner.

Point B is the intersection point of the first track segment AB and the second track segment BC.

In sub-block S231: a position relationship between the first track segment AB and the second track segment BC is determined according to the acquired data.

The position relationship may be at least one of the following: the one that the first track segment AB is exteriorly connected to the second track segment BC, and the one that the first track segment AB inscribes the second track segment BC.

In specific, when the first track segment AB is a straight line and the second track segment BC is an arc, the position relationship between the first track segment AB is a straight line and the second track segment BC is determined as the one that the first track segment AB is exteriorly connected to the second track segment BC or the one that the first track segment AB inscribes the second track segment BC, by comparing the angle formed by the first track segment AB and the circle center O₃ of the second track segment BC with a right angle.

When both the first track segment AB and the second track segment BC are arcs, it is determined whether the rotary direction of the first track segment AB is same with that of the second track segment BC and the position relationship therebetween is that the first track segment AB is exteriorly connected to or inscribes the second track segment BC, based on whether a selected direction vector gets through the first track segment AB and the second track segment BC, and whether the rotary direction of ∠O₁BO₃ formed by circle centers and point B is same with that of ∠ABC.

In sub-block S232: a distance L between circle centers is calculated based on the position relationship, a radius R₂ of a transitional arc EF and a radius R of at least one of the first track segment AB and the second track segment BC.

When the first track segment AB is a straight line and the second track segment BC is an arc, distance L₃₂ is calculated with the acquired position relationship, radius R₂ of the transitional arc EF and the radius R₃ of the second track segment BC. When both the first track segment AB and the second track segment BC are arcs, distances L₁₂ and L₃₂ are calculated with the acquired position relationship, radius R₂ of the transitional arc EF, the radius R₁ of the first track segment AB and the radius R₃ of the second track segment BC.

In sub-block S233: a coordinate (x_{O2}, y_{O2}) of a circle center O₂ of the transitional arc EF is calculated with the distance L and a coordinate of a circle center O.

In specific, When the first track segment AB is a straight line and the second track segment BC is an arc, distance L₃₂ is calculated with the acquired position relationship, radius R₂ of the transitional arc EF and the radius R₃ of the second track segment BC, and then the coordinate (x_{O2}, y_{O2}) of a circle center O₂ of the transitional arc EF is calculated with the distance L₃₂ and the circle center O₃ of the second track segment BC.

When both the first track segment AB and the second track segment BC are arcs, distances L₁₂ and L₃₂ are calculated with the acquired position relationship, radius R₂ of the transitional arc EF, the radius R₁ of the first track segment AB and the radius R₃ of the second track segment BC, and then the coordinate (x_{O2}, y_{O2}) of a circle center O₂ of the transitional arc EF is calculated with the distances L₁₂ and L₃₂, the circle center O₂ of the first track segment AB and the circle center O₃ of the second track segment BC.

In sub-block S234: coordinates (x_{E}, y_{E}) and (x_{F}, y_{F}) of end-points E and F are calculated with the radius R₂ and the coordinate of the circle center O₂, such that data of a track segment of the transitional arc EF is derived.

In sub-block S235: the corner is planned as data for numerical control machining path by combining the data of the track segment of the transitional arc EF and the data of the first track segment AB and the second track segment BC.

Further, the principle for determining what the arc transition type it is and the algorithm for determining the track segment of an arc are described in accompanying with the preset arc transition types.

As shown in FIG. 2, the first track segment AB is a straight line and the second track segment BC is an arc, where the arc EF is a transitional arc, both the straight line AB and the arc BC are machining tracks of one component, O₃ is the circle center of the arc BC, O₂ is the circle center of the transitional arc EF, and point B is the intersection point of the straight line AB and the arc BC. The point E of the transitional arc EF is a tangent point between the transitional arc EF and the straight line AB, point F is a tangent point between the transitional arc EF and the arc BC, and the direction of the transitional arc EF is opposite to that of the arc BC.

When ∠ABO₃>90°, the position relationship between the first track segment AB and the second track segment BC is that the first track segment AB is exteriorly connected to the second track segment BC.

$$R 2 = \frac{\vert ( {y}_{B} - {y}_{A} ) {x}_{{O}_{2}} + ( {x}_{A} - {x}_{B} ) {y}_{{O}_{2}} + ( {x}_{B} {y}_{A} - {x}_{A} {y}_{B} ) \vert}{\sqrt{{( {y}_{B} - {y}_{A} )}^{2} + {( {x}_{B} - {x}_{A} )}^{2}}} \qquad ( 1 )$$

Wherein (x_{A}, y_{A}) denotes a coordinate of point A and (x_{B}, y_{B}) denotes a coordinate of point B, which are known.

A distance between the circle center O₂ and the circle center O₃ is calculated with a following formula (2):

L₃₂=\sqrt{(y_{O3}−y_{O2})²+(x_{O3}−x_{O2})²}=R₃+R₂ (4)

(x_{O3}, y_{O3}) denotes coordinate of the circle center O₃, R₃ is a radius of the circle O₃ and R₂ is a radius of the circle O₂, which are all known. (x_{O2}, y_{O2}) denotes the coordinate of the circle center O₂, which is un-known.

The coordinate (x_{O2}, y_{O2}) of the circle center O₂ is calculated by both formula (1) and formula (4).

As mentioned above, the calculated coordinate (x_{O2}, y_{O2}) of the circle center O₂ has four sets of solutions. Furthermore, a screening condition is set to obtain a final value of the coordinate (x_{O2}, y_{O2}) from the four sets of solutions. The screening condition is that the direction from B to C of the arc BC is set as a positive direction after the circle centers O₃ and O₂ are connected, such that a solution which makes a value of ∠BO₃O₂ minimum is determined as what is needed, and thus the coordinate (x_{O2}, y_{O2}) of the circle center O₂ is determined finally.

As shown in FIG. 3, when ∠ABO₃<90°, the position relationship between the first track segment AB and the second track segment BC is that the first track segment AB circumscribes the second track segment BC.

A distance between the circle center O₂ and the circle center O₃ is calculated with a following formula (5):

L₃₂=\sqrt{(y_{O3}−y_{O2})²+(x_{O3}−x_{O2})²}=R₃−R₂ (5)

(x_{O3}, y_{O3}) denotes coordinate of the circle center O₃, R₃ is a radius of the circle O₃ and R₂ is a radius of the circle O₂, which are all known. (x_{O2}, y_{O2}) denotes the coordinate of the circle center O₂, which is un-known.

The coordinate (x_{O2}, y_{O2}) of the circle center O₂ is then calculated by the formulas (1) and (5) together.

As afore-mentioned, the calculated coordinate (x_{O2}, y_{O2}) of the circle center O₂ has four sets of solutions. Furthermore, a screening condition is set to obtain a final value of the coordinate (x_{O2}, y_{O2}) from the four sets of solutions. The screening condition is that the direction from B to C of the arc BC is set as a positive direction after the circle centers O₃ and O₂ are connected, such that a solution which makes a value of ∠BO₃O₂ minimum is determined as what is needed, and thus the coordinate (x_{O2}, y_{O2}) of the circle center O₂ is determined finally.

As afore-mentioned, the calculated coordinate (x_{O2}, y_{O2}) of the circle center O₂ has four sets of solutions. Furthermore, a screening condition is set to obtain a final value of the coordinate (x_{O2}, y_{O2}) from the four sets of solutions. The screening condition is that the direction from point B to point C of the arc BC is set as a positive direction after the circle centers O₃ and O₂ are connected, such that a solution which makes a value of ∠BO₃O₂ minimum is determined as what is needed, and thus the coordinate (x_{O2} y_{O2}) of the circle center O₂ is determined finally.

Then, the coordinates (x_{E}, y_{E}) and (x_{F}, y_{F}) of the end-points E and F are calculated respectively based on the coordinate (x_{O2}, y_{O2}) of the circle center O₂ and following formulas (2) and (3).

\sqrt{(y_{O3}−y_{B})²+(x_{O3}−x_{B})²}=\sqrt{(y_{O3}−y_{F})²+(x_{O3}−x_{F})²}=R₃ (2)

\sqrt{(y_{O2}−y_{E})²+(x_{O2}−x_{E})²}=\sqrt{(y_{O2}−y_{F})²+(x_{O2}−x_{F})²}=R₂ (3)

Therefore, an arc with the circle center O₂ and end points E and F is the needed transitional arc.

As shown in FIG. 4, both the first track segment AB and the second track segment BC are arcs, where an arc EF is a transitional arc, both the arc AB and the arc BC are machining tracks of one component, O₁ is the circle center of the arc BC, O₃ is the circle center of the arc BC, O₂ is the circle center of the transitional arc EF, and point B is the intersection point of the straight line AB and the arc BC. The point E of the transitional arc EF is a tangent point between the transitional arc EF and the arc AB, point F is a tangent point between the transitional arc EF and the arc BC.

As a selected direction vector gets through the first track segment AB and the second track segment BC, and the rotary direction of ∠O₁BO₃ is opposite to that of ∠ABC, it is determined that the rotary direction of the first track segment AB is same with that of the second track segment BC and the position relationship therebetween is that the first track segment AB is exteriorly connected to the second track segment BC.

A distance between the circle center O₁ and the circle center O₂ is calculated with a following formula (6):

L₁₂=R₁+R₂=\sqrt{(x_{O1}−x_{O2})²+(y_{O1}−y_{O2})²} (6)

A distance between the circle center O₂ and the circle center O₃ is calculated with a following formula (7):

L₃₂=R₂+R₃=\sqrt{(x_{O2}−x_{O3})²+(y_{O2}−y_{O3})²} (7)

(x_{O1}, y_{O1}) denotes coordinate of the circle center O₁, R₁ is a radius of the circle O₁, R₂ is a radius of the circle O₂, (x_{O3}, y_{O3}) denotes coordinate of the circle center O₃, and R₃ is a radius of the circle O₃, which are all known. (x_{O2}, y_{O2}) denotes the coordinate of the circle center O₂, which is un-known.

The coordinate of the circle center O₂ is calculated with the formulas (6) and (7).

As afore-mentioned, the calculated coordinate (x_{O2}, y_{O2}) of the circle center O₂ has two sets of solutions. A screening condition is set to finally determine the coordinate (x_{O2}, y_{O2}) of the circle center O₂, which is that one solution which is nearer to the intersection point B is used as the coordinate (x_{O2}, y_{O2}) of the circle center O₂.

Then, the coordinates (x_{E}, y_{E}) and (x_{F}, y_{F}) of the end-points E and F are calculated respectively based on the coordinate (x_{O2}, y_{O2}) of the circle center O₂ and following formulas (8)-(10).

\sqrt{(y_{O1}−y_{E})²+(x_{O1}−x_{E})²}=R₁ (8)

\sqrt{(y_{O3}−y_{F})²+(x_{O3}−x_{F})²}=R₃ (9)

\sqrt{(y_{O2}−y_{F})²+(x_{O2}−x_{F})²}=\sqrt{(y_{O2}−y_{E})²+(x_{O2}−x_{E})²}=R₂ (10)

Therefore, an arc with the circle center O₂ and end points E and F is the needed transitional arc.

As shown FIG. 5, both the first track segment AB and the second track segment BC are arcs, where an arc EF is a transitional arc, both the arc AB and the arc BC are machining tracks of one component, O₁ is the circle center of the arc BC, O₃ is the circle center of the arc BC, O₂ is the circle center of the transitional arc EF, and point B is the intersection point of the straight line AB and the arc BC. The point E of the transitional arc EF is a tangent point between the transitional arc EF and the arc AB, point F is a tangent point between the transitional arc EF and the arc BC.

As a selected direction vector gets through the first track segment AB and the second track segment BC, and the rotary direction of ∠O₁BO₃ is same with that of ∠ABC, it is determined that the rotary direction of the first track segment AB is same with that of the second track segment BC and the position relationship therebetween is that the first track segment AB is interiorly connected to the second track segment BC.

A distance between the circle center O₁ and the circle center O₂ is calculated with a following formula (11):

L₁₂=R₁−R₂=\sqrt{(x_{O1}−x_{O2})²+(y_{O1}−y_{O2})²} (11)

A distance between the circle center O₂ and the circle center O₃ is calculated with a following formula (12):

L₃₂=R₃−R₂=\sqrt{(x_{O3}−x_{O2})²+(y_{O3}−y_{O2})²} (12)

(x_{O1}, y_{O1}) denotes coordinate of the circle center O₁, R₁ is a radius of the circle O₁, (x_{O3}, y_{O3}) denotes coordinate of the circle center O₃, and R₃ is a radius of the circle O₃, which are all known. (x_{O2}, y_{O2}) denotes the coordinate of the circle center O₂, which is un-known.

The coordinate of the circle center O₂ is calculated with the formulas (11) and (12).

As afore-mentioned, the calculated coordinate (x_{O2}, y_{O2}) of the circle center O₂ has two sets of solutions. A screening condition is set to finally determine the coordinate (x_{O2}, y_{O2}) of the circle center O₂, which is that one solution which is nearer to the intersection point B is used as the coordinate (x_{O2}, y_{O2}) of the circle center O₂.

Similarly, the coordinates (x_{E}, y_{E}) and (x_{F}, y_{F}) of the end-points E and F are calculated respectively based on the coordinate (x_{O2}, y_{O2}) of the circle center O₂ and following formulas (8)-(10). Therefore, an arc with the circle center O₂ and end points E and F is the needed transitional arc.

As shown in FIG. 6, both the first track segment AB and the second track segment BC are arcs.

Whether a known arc is a top-arc or bottom-arc is determined according to a convex direction of the known arc (which is the first track segment AB or the second track segment BC). The top-arc is an arc which inscribes the transitional arc. The bottom-arc is an arc which is exteriorly connected to the transitional arc.

In specific, the convex direction is defined as follows. Taking arc BC as an example, any one point Mon the arc BC is selected except for end points, and point B is connected to points M and C respectively. If the position which BM is located may be obtained by rotating BC with θ(0˜90°) clockwise, the arc BC is called as a clockwise convex for the point B. In other word, the convex direction of the arc BC is clockwise for the point B. Obviously, in this case, the direction of the arc BC is same with that of the arc AB.

For the arc AB (of which circle center is O₁ and radius is R₁) and the arc BC (of which circle center is O₃ and radius is R₃) which are adjacent, the direction (i.e. rotary direction) of ∠O₁BO₃ formed by connecting the point B to O₁ and O₃ is same with the directions of the two arcs which are intersected at the point B, the arc AB is the bottom-arc of a transitional circle, and the arc BC is the top-arc. The relationships between distances L₁₂ and L₃₂ and a radius R₂ of the transitional circle, the radiuses R₁ and R₃ are listed as follows.

L₁₂=R₁+R₂=\sqrt{(x_{O1}−x_{O2})²+(y_{O1}−y_{O2})²} (13); and

L₃₂=R₃−R₂=\sqrt{(x_{O3}−x_{O2})²+(y_{O3}−y_{O2})²} (14).

On the contrary, the relationships are listed as follows.

L₁₂=R₁−R₂=\sqrt{(x_{O1}−x_{O2})²+(y_{O1}−y_{O2})²} (15)

L₃₂=R₃+R₂=\sqrt{(x_{O3}−x_{O2})²+(y_{O3}−y_{O2})²} (16).

Therefore, when the transitional arc EF inscribes the top-arc EC and is exteriorly connected to the bottom-arc AB, the coordinate of the circle center O₂ is calculated with the formulas (13) and (14) or (15) and (16).

As afore-mentioned, the calculated coordinate (x_{O2}, y_{O2}) of the circle center O₂ has two sets of solutions. A screening condition is set to finally determine the coordinate (x_{O2}, y_{O2}) of the circle center O₂, which is that one solution which is nearer to the intersection point B is used as the coordinate (x_{O2}, y_{O2}) of the circle center O₂.

Similarly, the coordinates (x_{E}, y_{E}) and (x_{F}, y_{F}) of the end-points E and F are calculated respectively based on the coordinate (x_{O2}, y_{O2}) of the circle center O₂ and following formulas (8)-(10). Therefore, an arc with the circle center O₂ and end points E and F is the needed transitional arc.

In block S24: the machining control module 13 generates a control command based on numerical control machining data to call the machining execution module 15 to drive the lathe to perform a corresponding machining operation on the arc transitional section. Then the process ends.

In block S25: the interpolation section determination module 12 determines whether there exists un-transmitted interpolation section data (which is data acquired by the machining control module 13) among the numerical control machining data needed to machine components. Block S26 will be executed when there exists. Otherwise, block S27 will be executed.

In the block S26: the interpolation section determination module 12 transmits the current section data to the machining control module 13, and meanwhile sets the flag as 0. At this time, the arc transition module 11 is enabled. Then the process goes back the block S24.

In block S27: the interpolation section determination module 12 transmits the current section data to the machining control module 13. Then the process goes back the block S24.

In the block S28: the interpolation section determination module 12 transmits the current section data to the machining control module 13, and meanwhile sets the flag as 1. At this time, the arc transition module 11 is enabled. Then the process goes back the block S24.

In the block S29: the interpolation section determination module 12 stores the current section data into the previous section data, which is to omit the current section data. Then the process ends.

In the present disclosure, a numerical control machining path planning method and a numerical control machining system and method are provided. A transitional arc between machining sections is completed by adding transition between an arc and a line, and an arc and an arc, avoiding impacts on the lathe, improving machining quality and meanwhile increasing machining efficiency.

In the present disclosure, a numerical control machining path planning method and a numerical control machining system and method are provided. Whether the arc transition module is enabled is controlled by system parameters and machining commands, and arc transition data is added according to the arc transition type of the current section data and the lathe is controlled to perform machining on the transition arc when the arc transition module is enabled, increasing flexibility and improving machining efficiency.

The above description depicts merely some exemplary embodiments of the present disclosure, but those skilled in the art may make various modifications to the present disclosure without departing from the spirit and scope of the present disclosure.

1. A numerical control matching path planning method, comprising:
acquiring data of a first track segment AB and a second track segment BC that are adjacent before planning, wherein the first track segment AB and the second track segment BC are intersected to form a corner;
determining a position relationship between the first track segment AB and the second track segment BC according to the acquired data;
calculating a distance between circle centers based on the position relationship, a radius R₂ of a transitional arc EF and a radius of at least one of the first track segment AB and the second track segment BC;
calculating a coordinate (x_{O2}, y_{O2}) of a circle center O₂ of the transitional arc EF with the distance and a coordinate of a circle center of the at least one of the first track segment AB and the second track segment BC;
calculating coordinates (x_{E}, y_{E}) and (x_{F}, y_{F}) of end-points E and F with the radius R₂ and the coordinate of the circle center O₂, thereby deriving data of a track segment of the transitional arc EF; and
planning the corner as data for numerical control machining path by combining the data of the track segment of the transitional arc EF and the data of the first track segment AB and the second track segment BC.

2. The method of claim 1, wherein when the first track segment AB is a line and the second track segment BC is an arc, a following formula (1) between the coordinate of the circle center O₂ and a radius R₂ is obtained:
$$R 2 = \frac{\vert ( {y}_{B} - {y}_{A} ) {x}_{{O}_{2}} + ( {x}_{A} - {x}_{B} ) {y}_{{O}_{2}} + ( {x}_{B} {y}_{A} - {x}_{A} {y}_{B} ) \vert}{\sqrt{{( {y}_{B} - {y}_{A} )}^{2} + {( {x}_{B} - {x}_{A} )}^{2}}} ; \qquad ( 1 )$$
in which (x_{A}, y_{A}) denotes a coordinate of point A and (x_{B}, y_{B}) denotes a coordinate of point B, which are all known; (x_{O2}, y_{O2}) denotes the coordinate of the circle center O₂, which is un-known; and
following formulas (2) and (3) among the coordinates (x_{E}, y_{E}) and (x_{F}, y_{F}) of the end-points E and F and a coordinate of a circle center O₃ and a radius R₃ of the second track segment and are obtained:
\sqrt{(y_{O3}−y_{B})²+(x_{O3}−x_{B})²}=\sqrt{(y_{O3}−y_{F})²+(x_{O3}−x_{F})²}=R₃ (2); and
\sqrt{(y_{O2}−y_{E})²+(x_{O2}−x_{E})²}=\sqrt{(y_{O2}−y_{F})²+(x_{O2}−x_{F})²}=R₂ (3);
in which (x_{O3}, y_{O3}) denotes coordinate of the circle center O₃ and (x_{O3}, y_{O3}) and R₃ are known.

3. The method of claim 2, wherein when ∠ABO₃<90°, the position relationship is that the first track segment AB circumscribes the second track segment BC;
the coordinate (x_{O2}, y_{O2}) of the circle center O₂ is calculated according to the formula (1) and a following formula (4):
$$R 2 = \frac{\vert ( {y}_{B} - {y}_{A} ) {x}_{{O}_{2}} + ( {x}_{A} - {x}_{B} ) {y}_{{O}_{2}} + ( {x}_{B} {y}_{A} - {x}_{A} {y}_{B} ) \vert}{\sqrt{{( {y}_{B} - {y}_{A} )}^{2} + {( {x}_{B} - {x}_{A} )}^{2}}} ; \qquad ( 1 )$$
L₃₂=\sqrt{(y_{O3}−y_{O2})²+(x_{O3}−x_{O2})²}=R₃+R₂ (4); and
the coordinates (x_{E}, y_{E}) and (x_{F}, y_{F}) of the end-points E and F are calculated according to the coordinate (x_{O2}, y_{O2}) and the formulas (2) and (3).

4. The method of claim 2, wherein when ∠ABO₃<90°, the position relationship is that the first track segment AB circumscribes the second track segment BC;
calculating the coordinate (x_{O2}, y_{O2}) of the circle center O₂ according to the formula (1) and a following formula (5):
$$R 2 = \frac{\vert ( {y}_{B} - {y}_{A} ) {x}_{{O}_{2}} + ( {x}_{A} - {x}_{B} ) {y}_{{O}_{2}} + ( {x}_{B} {y}_{A} - {x}_{A} {y}_{B} ) \vert}{\sqrt{{( {y}_{B} - {y}_{A} )}^{2} + {( {x}_{B} - {x}_{A} )}^{2}}} ; \qquad ( 1 )$$
L₃₂=\sqrt{(y_{O3}−y_{O2})²+(x_{O3}−x_{O2})²}=R₃−R₂ (5); and
the coordinates (x_{E}, y_{E}) and (x_{F}, y_{F}) of the end-points E and F are calculated according to the coordinate (x_{O2}, y_{O2}) and the formulas (2) and (3).

5. The method of claim 1, wherein when both the first track segment AB and the second track segment BC are arcs, and the position relationship is that the first track segment AB inscribes the second track segment BC, the coordinate (x_{O2}, y_{O2}) of the circle center O₂ is calculated according to following formulas (6) and (7):
L₁₂=R₁+R₂=\sqrt{(x_{O1}−x_{O2})²+(y_{O1}−y_{O2})²} (6); and
L₃₂=R₂+R₃=\sqrt{(x_{O2}−x_{O3})²+(y_{O2}−y_{O3})²} (7);
in which (x_{O1}, y_{O1}) denotes a coordinate of a circle center O₁ of the first track segment AB and R₁ denotes a radius of the first track segment AB, R₂ is a radius of the circle O₂, and (x_{O3}, y_{O3}) denotes a coordinate of a circle center O₃ of the second track segment BC and R₃ denotes a radius of the second track segment BC, which are all known; (x_{O2}, y_{O2}) denotes the coordinate of the circle center O₂, which is un-known; and
the coordinates (x_{E}, y_{E}) and (x_{F}, y_{F}) of the end-points E and F are calculated according to the coordinate (x_{O2}, y_{O2}) and following formulas (8), (9) and (10):
\sqrt{(y_{O1}−y_{E})²+(x_{O1}−x_{E})²}=R₁ (8),
\sqrt{(y_{O3}−y_{F})²+(x_{O3}−x_{F})²}=R₃ (9); and
\sqrt{(y_{O2}−y_{F})²+(x_{O2}−x_{F})²}=\sqrt{(y_{O2}−y_{E})²+(x_{O2}−x_{E})²}=R₂ (10).

6. The method of claim 1, wherein when both the first track segment AB and the second track segment BC are arcs and the position relationship is that the first track segment AB is exteriorly connected to the second track segment BC, the coordinate (x_{O2}, y_{O2}) of the circle center O₂ is calculated according to following formulas (11) and (12):
L₁₂=R₁−R₂=\sqrt{(x_{O1}−x_{O2})²+(y_{O1}−y_{O2})²} (11); and
L₃₂=R₃−R₂=\sqrt{(x_{O3}−x_{O2})²+(y_{O3}−y_{O2})²} (12);
in which (x_{O1}, y_{O1}) denotes a coordinate of a circle center O₁ of the first track segment AB and R₁ denotes a radius of the first track segment AB, E₂ is a radius of the circle O₂, and (x_{O3}, y_{O3}) denotes a coordinate of a circle center O₃ of the second track segment BC and R₃ denotes a radius of the second track segment BC, which are all known; (x_{O2}, y_{O2}) denotes the coordinate of the circle center O₂, which is un-known; and
the coordinates (x_{E}, y_{E}) and (x_{F}, y_{F}) of the end-points E and F are calculated according to the coordinate (x_{O2}, y_{O2}) and following formulas (8), (9) and (10):
\sqrt{(y_{O1}−y_{E})²+(x_{O1}−x_{E})²}=R₁ (8),
\sqrt{(y_{O3}−y_{F})²+(x_{O3}−x_{F})²}=R₃ (9); and
\sqrt{(y_{O2}−y_{F})²+(x_{O2}−x_{F})²}=\sqrt{(y_{O2}−y_{E})²+(x_{O2}−x_{E})²}=R₂ (10).

7. The method of claim 1, wherein when both the first track segment AB and the second track segment BC are arcs, and the transitional arc EF is interiorly connected to the first track segment AB and exteriorly connected to the second track segment BC, the coordinate (x_{O2}, y_{O2}) of the circle center O₂ is calculated according to following formulas (13) and (14):
L₁₂=R₁+R₂=\sqrt{(x_{O1}−x_{O2})²+(y_{O1}−y_{O2})²} (13); and
L₃₂=R₃−R₂=\sqrt{(x_{O3}−x_{O2})²+(y_{O3}−y_{O2})²} (14);
in which (x_{O1}, y_{O1}) denotes a coordinate of a circle center O₁ of the first track segment AB and R₁ denotes a radius of the first track segment AB, E₂ is a radius of the circle O₂ and (x_{O3}, y_{O3}) denotes a coordinate of a circle center O₃ of the second track segment BC and R₃ denotes a radius of the second track segment BC, which are all known; (x_{O2}, y_{O2}) denotes the coordinate of the circle center O₂, which is un-known; and
the coordinates (x_{E}, y_{E}) and (x_{F}, y_{F}) of the end-points E and F are calculated according to the coordinate (x_{O2}, y_{O2}) and following formulas (8), (9) and (10):
\sqrt{(y_{O1}−y_{E})²+(x_{O1}−x_{E})²}=R₁ (8),
\sqrt{(y_{O3}−y_{F})²+(x_{O3}−x_{F})²}=R₃ (9); and
\sqrt{(y_{O2}−y_{F})²+(x_{O2}−x_{F})²}=\sqrt{(y_{O2}−y_{E})²+(x_{O2}−x_{E})²}=R₂ (10).

8. A numerical control machining system, comprising:
a memory storing a plurality of programs and a plurality of sets of numerical control machining data and a processor; wherein each set of numerical control machining data is configured to indicate a size of a component needed to be machined, and the programs when executed by the processor, cause the processor to perform operations, comprising:
acquiring numerical control machining data of the component from the memory, and generate a numerical control machining command according to the numerical control machining data;
driving a lathe to execute a machining operation on the component in response to the numerical control machining command;
determining whether currently-executed program section data and un-executed program section data among the numerical control machining data are interpolation section data, and generating a first result to obtain one program section data; and
adding track data of an arc according to the first result and a second result whether a machining type described by currently-executed program section data is one of preset arc transitional types;
generating a control command according to the added track data of the arc to drive the lathe to perform corresponding machining operation on a transition section.

9. The system of claim 8, wherein when both the currently-executed program section data and un-executed program section data among the numerical control machining data are determined to be not interpolation section data, the currently-executed program section data is transmitted, a flag isn't set for the interpolation section data, and adding the track data of the arc is disenabled;
when the currently-executed program section data is not interpolation section data, and the un-executed program section data among the numerical control machining data is the interpolation section data, the currently-executed program section data is transmitted, a flag is set as 0 for the interpolation section data, and adding the track data of the arc is enabled;
when the currently-executed program section data is interpolation section data, and the un-executed program section data among the numerical control machining data is not the interpolation section data, the currently-executed program section data is transmitted, a flag is set as 1 for the interpolation section data, and adding the track data of the arc is enabled; and
when both the currently-executed program section data and un-executed program section data in the numerical control machining data are determined to be interpolation section data, adding the track data of the arc is directly enabled.

10. The system of claim 8, wherein the operations further comprises: determining the track data of the arc, wherein the determining the track data of the arc comprises:
acquiring data of a first track segment AB and a second track segment BC that are adjacent before planning, wherein the first track segment AB and the second track segment BC are intersected to form a corner;
determining a position relationship between the first track segment AB and the second track segment BC according to the acquired data;
calculating a distance between circle centers based on the position relationship, a radius R₂ of a transitional arc EF and a radius of at least one of the first track segment AB and the second track segment BC;
calculating a coordinate (x_{O2}, y_{O2}) of a circle center O₂ of the transitional arc EF with the distance L and a coordinate of a circle center of the at least one of the first track segment AB and the second track segment BC;
calculating coordinates (x_{E}, y_{E}) and (x_{F}, y_{F}) of end-points E and F with the radius R₂ and the coordinate of the circle center O₂, thereby acquiring data of a track segment of the transitional arc EF; and
planning the corner as data for numerical control machining path by combining the data of the track segment of the transitional arc EF and the data of the first track segment AB and the second track segment BC.

11. A numerical control machining method, comprising:
determining whether currently-executed program section data and un-executed program section data are interpolation section data, and generate a first result to obtain one program section data;
adding track data of an arc according to the first result and a second result whether a machining type described by currently-executed program section data is one of preset arc transitional types; and
generating a control command according to the added track data of the arc to drive a lathe to perform corresponding machining operation on a transition section.

12. The method of claim 11, further comprising: determining the track data of the arc;
wherein the determining the track data of the arc comprises:
acquiring data of a first track segment AB and a second track segment BC that are adjacent before planning, wherein the first track segment AB and the second track segment BC are intersected to form a corner;
determining a position relationship between the first track segment AB and the second track segment BC according to the acquired data;
calculating a distance between circle centers based on the position relationship, a radius R₂ of a transitional arc EF and a radius of at least one of the first track segment AB and the second track segment BC;
calculating a coordinate (x_{O2}, x_{O2}) of a circle center O₂ of the transitional arc EF with the distance and a coordinate of a circle center of the at least one of the first track segment AB and the second track segment BC;
calculating coordinates (x_{E}, y_{E}) and (x_{F}, y_{F}) of end-points E and F with the radius R₂ and the coordinate of the circle center O₂, thereby deriving data of a track segment of the transitional arc EF; and
planning the corner as data for numerical control machining path by combining the data of the track segment of the transitional arc EF and the data of the first track segment AB and the second track segment BC.

13. The method of claim 12, wherein the determining the track data of the arc further comprises:
when the first track segment AB is a line and the second track segment BC is an arc, a following formula (1) between the coordinate of the circle center O₂ and a radius R₂ is obtained:
$$R 2 = \frac{\vert ( {y}_{B} - {y}_{A} ) {x}_{{O}_{2}} + ( {x}_{A} - {x}_{B} ) {y}_{{O}_{2}} + ( {x}_{B} {y}_{A} - {x}_{A} {y}_{B} ) \vert}{\sqrt{{( {y}_{B} - {y}_{A} )}^{2} + {( {x}_{B} - {x}_{A} )}^{2}}} ; \qquad ( 1 )$$
in which (x_{A}, y_{A}) denotes a coordinate of point A and (x_{B}, y_{B}) denotes a coordinate of point B, which are all known; (x_{O2}, y_{O2}) denotes the coordinate of the circle center O₂, which is un-known; and
following formulas (2) and (3) among the coordinates (x_{E}, y_{E}) and (x_{F}, y_{F}) of the end-points E and F and a coordinate of a circle center O₃ and a radius R₃ of the second track segment and are obtained:
\sqrt{(y_{O3}−y_{B})²+(x_{O3}−x_{B})²}=\sqrt{(y_{O3}−y_{F})²+(x_{O3}−x_{F})²}=R₃ (2); and
\sqrt{(y_{O2}−y_{E})²+(x_{O2}−x_{E})²}=\sqrt{(y_{O2}−y_{F})²+(x_{O2}−x_{F})²}=R₂ (3);
in which (x_{O3}, y_{O3}) denotes coordinate of the circle center O₃ and (x_{O3}, y_{O3}) and R₃ are known.

14. The method of claim 13, wherein the determining the track data of the arc further comprises:
when ∠ABO₃<90°, the position relationship is that the first track segment AB circumscribes the second track segment BC;
the coordinate (x_{O2}, y_{O2}) of the circle center O₂ is calculated according to the formula (1) and a following formula (4):
$$R 2 = \frac{\vert ( {y}_{B} - {y}_{A} ) {x}_{{O}_{2}} + ( {x}_{A} - {x}_{B} ) {y}_{{O}_{2}} + ( {x}_{B} {y}_{A} - {x}_{A} {y}_{B} ) \vert}{\sqrt{{( {y}_{B} - {y}_{A} )}^{2} + {( {x}_{B} - {x}_{A} )}^{2}}} ; \qquad ( 1 )$$
L₃₂=\sqrt{(y_{O3}−y_{O2})²+(x_{O3}−x_{O2})²}=R₃+R₂ (4); and
the coordinates (x_{E}, y_{E}) and (x_{F}, y_{F}) of the end-points E and F are calculated according to the coordinate (x_{O2}, y_{O2}) and the formulas (2) and (3).

15. The method of claim 13, wherein the determining the track data of the arc further comprises:
when ∠ABO₃<90°, the position relationship is that the first track segment AB circumscribes the second track segment BC;
calculating the coordinate (x_{O2}, y_{O2}) of the circle center O₂ according to the formula (1) and a following formula (5):
$$R 2 = \frac{\vert ( {y}_{B} - {y}_{A} ) {x}_{{O}_{2}} + ( {x}_{A} - {x}_{B} ) {y}_{{O}_{2}} + ( {x}_{B} {y}_{A} - {x}_{A} {y}_{B} ) \vert}{\sqrt{{( {y}_{B} - {y}_{A} )}^{2} + {( {x}_{B} - {x}_{A} )}^{2}}} ; \qquad ( 1 )$$
L₃₂=\sqrt{(y_{O3}−y_{O2})²+(x_{O3}−x_{O2})²}=R₃−R₂ (5); and
the coordinates (x_{E}, y_{E}) and (x_{F}, y_{F}) of the end-points E and F are calculated according to the coordinate (x_{O2}, y_{O2}) and the formulas (2) and (3).

16. The method of claim 12, wherein the determining the track data of the arc further comprises:
when both the first track segment AB and the second track segment BC are arcs, and the position relationship is that the first track segment AB inscribes the second track segment BC, the coordinate (x_{O2}, y_{O2}) of the circle center O₂ is calculated according to following formulas (6) and (7):
L₁₂=R₁+R₂=\sqrt{(x_{O1}−x_{O2})²+(y_{O1}−y_{O2})²} (6); and
L₃₂=R₂+R₃=\sqrt{(x_{O2}−x_{O3})²+(y_{O2}−y_{O3})²} (7);
in which (x_{O1}, y_{O1}) denotes a coordinate of a circle center O₁ of the first track segment AB and R₁ denotes a radius of the first track segment AB, R₂ is a radius of the circle O₂, and (x_{O3}, y_{O3}) denotes a coordinate of a circle center O₃ of the second track segment BC and R₃ denotes a radius of the second track segment BC, which are all known; (x_{O2}, y_{O2}) denotes the coordinate of the circle center O₂, which is un-known; and
the coordinates (x_{E}, y_{E}) and (x_{F}, y_{F}) of the end-points E and F are calculated according to the coordinate (x_{O2}, y_{O2}) and following formulas (8), (9) and (10):
\sqrt{(y_{O1}−y_{E})²+(x_{O1}−x_{E})²}=R₁ (8),
\sqrt{(y_{O3}−y_{F})²+(x_{O3}−x_{F})²}=R₃ (9); and
\sqrt{(y_{O2}−y_{F})²+(x_{O2}−x_{F})²}=\sqrt{(y_{O2}−y_{E})²+(x_{O2}−x_{E})²}=R₂ (10).

17. The method of claim 12, wherein the determining the track data of the arc further comprises:
when both the first track segment AB and the second track segment BC are arcs and the position relationship is that the first track segment AB is exteriorly connected to the second track segment BC, the coordinate (x_{O2}, y_{O2}) of the circle center O₂ is calculated according to following formulas (11) and (12):
L₁₂=R₁−R₂=\sqrt{(x_{O1}−x_{O2})²+(y_{O1}−y_{O2})²} (11); and
L₃₂=R₃−R₂=\sqrt{(x_{O3}−x_{O2})²+(y_{O3}−y_{O2})²} (12);
in which (x_{O1}, y_{O1}) denotes a coordinate of a circle center O₁ of the first track segment AB and R₁ denotes a radius of the first track segment AB, R₂ is a radius of the circle O₂, and (x_{O3}, y_{O3}) denotes a coordinate of a circle center O₃ of the second track segment BC and R₃ denotes a radius of the second track segment BC, which are all known; (x_{O2}, y_{O2}) denotes the coordinate of the circle center O₂, which is un-known; and
the coordinates (x_{E}, y_{E}) and (x_{F}, y_{F}) of the end-points E and F are calculated according to the coordinate (x_{O2}, y_{O2}) and following formulas (8), (9) and (10):
\sqrt{(y_{O1}−y_{E})²+(x_{O1}−x_{E})²}=R₁ (8),
\sqrt{(y_{O3}−y_{F})²+(x_{O3}−x_{F})²}=R₃ (9); and
\sqrt{(y_{O2}−y_{F})²+(x_{O2}−x_{F})²}=\sqrt{(y_{O2}−y_{E})²+(x_{O2}−x_{E})²}=R₂ (10).

18. The method of claim 12, wherein the determining the track data of the arc further comprises:
when both the first track segment AB and the second track segment BC are arcs, and the transitional arc EF is interiorly connected to the first track segment AB and exteriorly to the second track segment BC, the coordinate (x_{O2}, y_{O2}) of the circle center O₂ is calculated according to following formulas (13) and (14):
L₁₂=R₁+R₂=\sqrt{(x_{O1}−x_{O2})²+(y_{O1}−y_{O2})²} (13); and
L₃₂=R₃−R₂=\sqrt{(x_{O3}−x_{O2})²+(y_{O3}−y_{O2})²} (14);
in which (x_{O1}, y_{O1}) denotes a coordinate of a circle center O₁ of the first track segment AB and R₁ denotes a radius the first track segment AB, R₂ is a radius of the circle O₂, and (x_{O3}, y_{O3}) denotes a coordinate of a circle center O₃ of the second track segment BC and R₃ denotes a radius of the second track segment BC, which are all known; (x_{O2}, y_{O2}) denotes the coordinate of the circle center O₂, which is un-known; and
the coordinates (x_{E}, y_{E}) and (x_{F}, y_{F}) of the end-points E and F are calculated according to the coordinate (x_{O2}, y_{O2}) and following formulas (8), (9) and (10):
\sqrt{(y_{O1}−y_{E})²+(x_{O1}−x_{E})²}=R₁ (8),
\sqrt{(y_{O3}−y_{F})²+(x_{O3}−x_{F})²}=R₃ (9); and
\sqrt{(y_{O2}−y_{F})²+(x_{O2}−x_{F})²}=\sqrt{(y_{O2}−y_{E})²+(x_{O2}−x_{E})²}=R₂ (10).
